(19) United States
(12) Patent Application Publication
(10) Pub. No.: US 2017/0103433 A1
(43) Pub. Date: Apr. 13, 2017

(54) Generating and Using Estimated Asset Monetary Values and Estimated Macroeconomic Measure Data Values

(71) Applicants: Gordon Michael Phillips, Pasadena, CA (US); James Tzeh-min Chong, Montrose, CA (US); Demosthenes A. Halcoussis, Canyon Country, CA (US); William Palmer Jennings, Simi Valley, CA (US)

(72) Inventors: Gordon Michael Phillips, Pasadena, CA (US); James Tzeh-min Chong, Montrose, CA (US); Demosthenes A. Halcoussis, Canyon Country, CA (US); William Palmer Jennings, Simi Valley, CA (US)

(73) Assignee: C4CAST.COM, INC., Pasadena, CA (US)

(21) Appl. No.: 14/259,879

(22) Filed: Apr. 23, 2014

(51) Int. Cl. G06Q 30/06

(52) U.S. Cl. CPC G06Q 30/06

(57) ABSTRACT

Provided are, among other things, systems, methods and techniques for estimating the value of a macroeconomic measure, e.g., by: (a) generating a mapping from a first set of data values for macroeconomic variables to monetary values for a second set of assets based on historical data values for the macroeconomic variables and historical monetary values of the assets; generating estimates of the monetary values of the assets by inputting data values for macroeconomic variables into the mapping; and generating an estimate of a data value for at least one of the macroeconomic variables using the mapping and known monetary values for the assets.

### FIELD OF THE INVENTION

The present invention pertains, among other things, to systems, methods and techniques for estimating values for different kinds of variables, typically asset monetary values and macroeconomic measure data values, and then using such estimated values, e.g., in connection with the purchasing, selling and/or evaluation of various kinds of assets and/or in connection with the allocation of various resources.

### BACKGROUND

The federal government periodically announces data values for various macroeconomic measures, such as employment and unemployment figures, labor force participation data, crop production forecasts, consumer spending data, interest rates, and various price indexes. Each of these measures is extremely important in a number of different markets and directly affects the monetary values markets place on individual assets (e.g., financial assets, businesses and commodities). Those monetary values, in turn, have direct effects on how resources are allocated throughout the economy, as well as on decisions made by individual businesses. In short, having the best information possible regarding the true data values for various macroeconomic measures can not only allow individuals to profit financially, but can permit the entire economy to respond in ways that shift resources toward their most productive uses.

However, it often is the case that certain macroeconomic values either are not provided at all (e.g., as was the case during the recent federal government shutdown), are delayed, or are provided with less-than-optimal accuracy. In this latter regard, such values, simply by virtue of the fact that they reflect some aspect of a very large national economy, typically cannot be accurately determined, but instead often must be estimated based on methodologies and assumptions that are believed to be reasonable, but nevertheless result in some amount of error or uncertainty.

### SUMMARY OF THE INVENTION

Among its other contributions, the present invention addresses this problem, e.g., by providing systems, methods and techniques for generating estimates of both asset monetary values and macroeconomic quantities using a single overall mapping, based on the best available information (e.g., which can be any combination of inputs and/or outputs to the mapping), such as monetary values that markets have placed on the various assets, typically publicly traded assets such as financial assets and/or commodities, and available data regarding macroeconomic quantities.

In one respect, the preferred embodiments of the present invention use an existing mapping for estimating asset monetary values and treat known asset values as a kind of consensus estimate which inherently is based, among other things, on the market's expectations regarding the values of related macroeconomic measures. After constructing an appropriate set of assets for a particular macroeconomic measure, the techniques of the present invention generally are able to essentially isolate out the market's implicit estimate regarding the value(s) of the desired individual macroeconomic measure(s). As discussed in greater detail below, such macroeconomic measure data value estimates also can be based on provided (e.g., forecasted or otherwise estimated) values of other related macroeconomic measures, in addition to asset monetary values assigned by the market.

Thus, one embodiment of the invention is directed to systems, methods and techniques for estimating the value of a macroeconomic measure, by: (a) generating a mapping from a first set of data values for macroeconomic variables to monetary values for a second set of assets based on historical data values for the macroeconomic variables and historical monetary values of the assets; generating estimates of the monetary values of the assets by inputting data values for macroeconomic variables into the mapping; and generating an estimate of a data value for at least one of the macroeconomic variables using the mapping and known monetary values for the assets.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram illustrating a variable-estimation system according to a representative embodiment of the present invention.

FIG. 2 is a flow diagram illustrating a process for estimating the values of different kinds of variables according to the present invention.

FIG. 3 is a flow diagram illustrating a sub-process for estimating data values of one or more target predictor variables, using combinations of different estimations for the same target predictor variable(s).

FIG. 4 is a flow diagram illustrating a sub-process for estimating data values of one or more target predictor variables, using a searching strategy.

FIG. 5 is a block diagram showing interactions between exemplary components when estimating values of macroeconomic variables and then using such estimated values.

### DESCRIPTION OF THE PREFERRED EMBODIMENT(S)

The present invention is related to commonly assigned U.S. patent application Ser. No.: (1) 13/237,856 (the '856 application), filed Sep. 20, 2011; (2) U.S. Ser. No. 13/841,062 (the '062 application), filed Mar. 15, 2013; and (3) U.S. Ser. No. 10/931,623 (the '623 application), filed Aug. 31, 2004 (now U.S. Pat. No. 8,494,940). Each of the foregoing patent applications is incorporated by reference herein as though set forth herein in full. Collectively, they are referred to herein as the “related patent applications”.

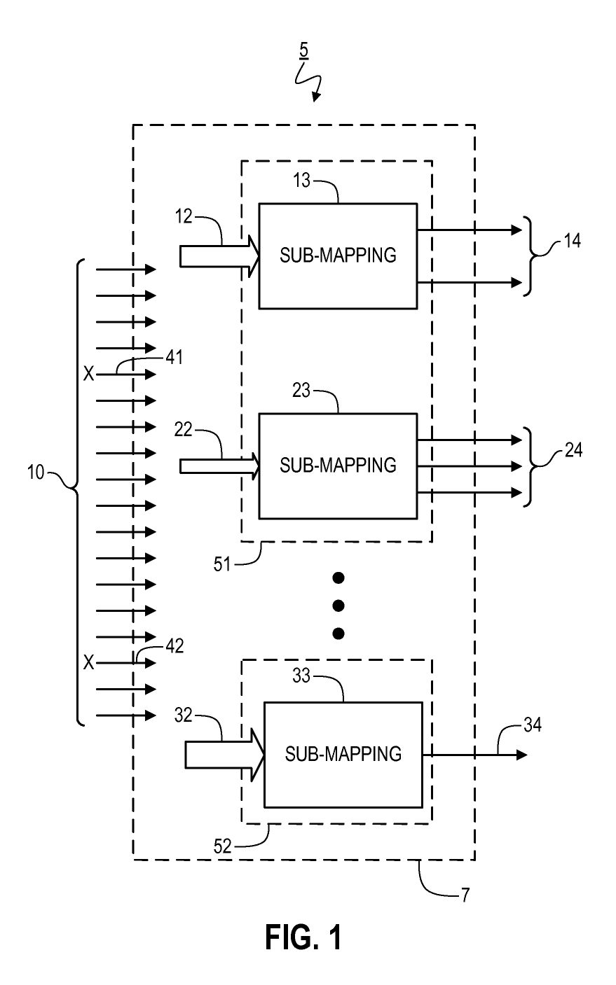

As shown in FIG. 1, a system 5 according to the preferred embodiments of the present invention involves the use of a mapping function 7, which inputs values for certain “predictor variables” (or PVs) 10 and, based on them, outputs (or generates) estimates values of certain “subject variables” (or SVs), such as subject variables 14, 24 and 34. Preferably, at least 12, 15, 20 or 30 predictor variables 10 are input and at least 100, 200, 500 or 1,000 subject variables 14, 24 and 34 can be output from mapping function 7. As discussed in greater detail below, mapping function 7 often will include multiple sub-mapping functions 13, 23 and 33 for estimating individual ones or relatively small groups of the subject variables 14, 24 and 34. In such embodiments, the sub-mapping functions 13, 23 and 33 often can be considered relatively independent of each other, with the conceptual representation of a single overall mapping function 7 merely reflecting the fact that a common (typically, relatively small) set of predictor variables 10 is used across all the sub-mapping functions 13, 23 and 33 to predict (or otherwise estimate) values for a typically large number of subject variables 14, 24 and 34. Except to the extent explicitly stated otherwise, references to the overall mapping function 7 can refer to the entire mapping or any portion (e.g., one or more of the sub-mapping functions 13, 23 and 33) of it.

In a typical implementation of system 5 (discussed throughout this disclosure), the predictor variables 10 include a set of macroeconomic variables (i.e., having data values that are indicative of broad economic conditions), and the subject variables 14, 24 and 34 represent monetary values of particular assets. In one specific embodiment, the predictor variables 10 are the 18 measures or factors (sometimes referred to as Eta factors) identified in the '623 application. However, any other variables also or instead may be used, such as any other macroeconomic variables and/or any other type of variables that are expected to (or empirically determined to) influence (or at least be correlated with or otherwise statistically related to) the values of the subject variables. Examples include variables pertaining to: weather or climate conditions, popular sentiments or preferences, sentiments or preferences of more narrowly defined groups of individuals, monetary values of other assets (e.g., at any appropriate point in time), monetary values of the subject variables at other (e.g., earlier) points in time, and/or any of the other predictor variables identified in the related patent applications.

Preferably, the predictor variables 10 are identified empirically as those that have demonstrated (based on historical data) a statistical relationship (either in a positive or negative sense) to the subject variables 14, 24 and 34 that are intended to be estimated. In addition, it should be noted that any of the predictor variables 10 can be defined as the actual values of certain measured quantities (e.g., new housing starts or money supply) or instead can be defined as the changes in such quantities from the last regular periodically announced (e.g., daily, monthly or quarterly) values. In any event, the predictor variables 10 preferably are defined without reference to any specific time, so that each variable 10 has associated with it a stream of values, typically coming in at regular, discrete time intervals, but in some cases (e.g., variables pertaining to publicly traded asset prices or to weather conditions) being updated on a continuous or nearly continuous basis, and in other cases coming in at irregular intervals.

In the present embodiment, mapping function 7 is divided into a plurality of “sub-mapping” functions (e.g., sub-mapping functions 13, 23 and 33). Each such sub-mapping function 13, 23 or 33, in turn, inputs a set of predictor variable instances 12, 22 or 32, respectively, and outputs values for a subset 14, 24 or 34 of the subject variables produced by the overall mapping function 7. Each such set of predictor variable instances 12, 22 or 32 might include samples from the entire set of predictor variables 10 and/or might include samples from just a subset of the predictor variables 10 (e.g., chosen to be those that are significantly statistically related to the corresponding subject variables 14, 24 and 34) and/or specific instances of them. In this latter regard, predictor variables 10 typically will be a standard, often more generalized, set of variables that are common across the various sub-mappings 13, 23 and 33, each typically representing a continual stream of data values. However, the predictor variable instances 12, 22 and 32 can include different time samples of these generalized variables 10, i.e., values of the variables 10 evaluated at (or with respect to) different selected points (or intervals) in time.

For example, in reference to sub-mapping function 13, one or more specific relative points in time may be selected for each of the predictor variables 10, to be used as the predictor variable instances 12, based on the amount of time by which such predictor variable 10 is a leading indicator of the corresponding subject variables 14. Preferably, the time instances for the variables 10 are chosen based on historical data so as to correspond to those values that are best correlated with (or otherwise most statistically related to, either in a positive or negative sense) the subject variables 14. For example, it might be determined that the values of the subject variables 14 (which can be referred to as Y₁ and Y₂, respectively) at a time t are best estimated using

[Y₁(t), Y₂(t)]=F[X₁(t−3), X₁(t−5), X₂(t−4), . . . ],

where the Xᵢ(·) are various input predictor variables 10, the time-specific instances of the Xᵢ are the input predictor variable instances 12, and the indicated time offsets are expressed in hours, days, weeks, months, quarters, or any other unit of time.

As indicated, multiple time instances of the same input predictor variable 10 (e.g., X₁) can be used to predict or otherwise estimate the same subject variables 14 (potentially with different levels of estimation power). Also, in some cases an input predictor variable 10 is only available at coarse time intervals, so in such cases the announced value closest in time to the desired time instant is used (with or without a correction factor in F[·] to account for the time difference), or an extrapolated or interpolated value of that predictor variable 10 is used.

In the foregoing example, all of the values of the predictor variable instances 12 are taken at a time earlier than the desired values of the subject variables 14, so that the estimation performed by sub-mapping function 13 is a form of prediction, which typically is the desired outcome. However, values for any or all of such predictor variables 12 can be taken at a time contemporaneous with or even later than the desired values of the subject variables 14, resulting in an estimation of the current or even past values of such subject variables 14. Such estimations might be capable of being determined earlier and/or might be more accurate than other competing (e.g., conventional) estimates for such subject variable values 14 and, therefore, often can be quite advantageous.

As discussed in greater detail below, in the preferred embodiments, automated techniques are used for identifying the predictor variables 12, 22 and 32 and their corresponding sub-mappings 13, 23 and 33. More preferably, the user is able to specify any constraints on the selected predictor variables 12, 22 and 32 (e.g., earlier in time only, so as to generate a prediction) in relation to the corresponding individual subject variables 14, 24 and 34.

Any of a variety of techniques can be used to select the predictor variable instances 12, 22 or 32 for the desired subject variables 14, 24 or 34, respectively, such as stepwise (e.g., linear) regression, neural network techniques, data-mining techniques, or any of the techniques discussed in the related patent applications. When a common set of predictor variable instances 12 is identified for two different subject variables 14, a common sub-mapping 13 can be used to estimate the values of such variables 14. Often, the sub-mapping 13 (including, e.g., the parameters of a previously specified estimation form, or both the estimation form and its parameters) will be identified simultaneously with the predictor variable instances 12 and/or the subject variables 14, as statistical relationships are identified. Exemplary approaches of this type can employ a neural network, a genetic algorithm and/or a data-mining technique.

In any event, the result of the foregoing process preferably is a set of one or more sub-mappings 13, 23 and 33, each having its own set of predictor variable instances 12, 22 and 32, respectively, which might include different numbers of predictor variables 10 and/or different time instances of the same general predictor variables 10. Similarly, the individual sub-mappings 13, 23 and 33 can result in different numbers of subject variables 14, 24 and 34, respectively, that are estimated.

It is noted that although only three different sub-mappings 13, 23 and 33 are shown in FIG. 1, there may be any number of such sub-mappings, e.g., more than 100, 500 or even 1,000. Similarly, each individual sub-mapping 13, 23 or 33 can result in the estimation of any number of subject variables 14, 24 and 34, although in many cases a separate sub-mapping function (e.g., 33) will be used for a single subject variable (e.g., 34). In certain embodiments, a separate sub-mapping function will be determined for each of more than 50%, 70%, 90% or even 95% of the subject variables estimated by mapping function 7.

In addition to estimating data values for different subject variables (e.g., variables 14, 24 and 34), the preferred techniques of the present invention also allow estimation of the values of the predictor variables 10. Estimates of such values might be desirable, e.g.: (1) in situations where the government or other body that typically announces them fails to do so on a regularly expected announcement date, (2) where an estimate earlier than the official announcement date is desired, (3) where a check on the officially announced figure is desired; and/or (4) where more frequent estimates are desired than are provided through official announcements. Thus, for example, FIG. 1 also depicts a situation in which values 41 and 42 for two of the predictor variables (from the entire set of predictor variables 10), which need not be in reference to this same point in (or period of) time, are desired to be estimated. Other values for these predictor variables 10 typically will be available but, e.g., values 41 and 42 are missing, or earlier and/or better estimates are desired. Although the present discussion typically assumes two such missing values (41 and 42), the same techniques can be used for any one or more such missing predictor variable values.

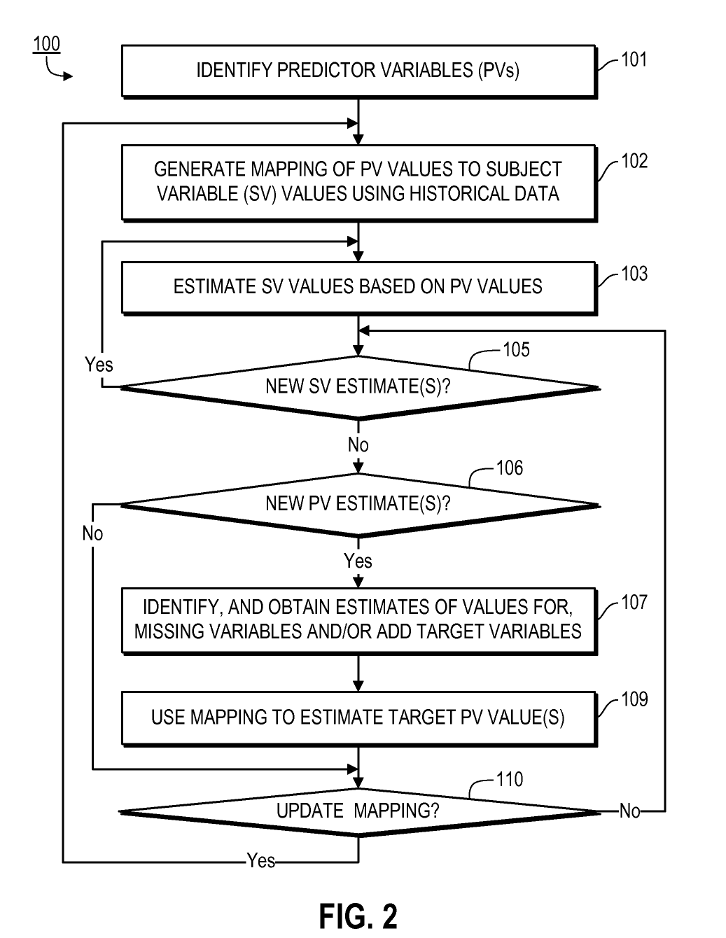

A representative process 100 for generating estimates of the values of the different types of variables mentioned above (e.g., both subject variables and predictor variables) is now discussed, primarily in reference to FIG. 2. Typically, process 100 is executed in whole or in part by one or more computing devices, executing machine-readable process steps stored on a tangible, non-transitory medium. Such computing devices ordinarily will include one or more Internet servers. However, any other computing devices (e.g., any of the devices discussed below) may be used instead (or in addition). Generally speaking, process 100 assumes that a set of subject variables (whose data values are desired to be estimated) has been identified and that historical data for the subject variables and for a set of potential predictor variables (from which the actual predictor variables 10 ultimately will be selected) have been obtained. However, in alternate embodiments the predictor variables 10 are pre-specified and the set of subject variables whose values can be reliably predicted based on them subsequently are identified.

Initially, in step 101 a set of predictor variables 10 is identified. Preferably, Each such predictor variable 10 has a value that is statistically correlated with (or otherwise statistically related to) the value of at least one (and, more preferably, several or all) of the subject variables 14, 24 and 34 whose values are desired to be estimated. As noted above, in the current embodiment the predictor variables 10 include a set of macroeconomic variables and the subject variables 14, 24 and 34 include a set of asset variables. However, any other kinds of variables also (or instead) may be used, for the predictor variables 10 and/or for the subject variables 14, 24 and 34.

In this step 101, the predictor variables 10 can be identified: (1) heuristically; (2) using a more computationally focused approach, such as one or more of stepwise linear regression, neural network techniques, data-mining techniques or any other approach for identifying a statistical relationship between a first set of one or more variables and the second set of one or more variables; or (3) using any combination of the foregoing approaches. In the present embodiment, the predictor variables 10 generally are assumed to be macroeconomic measures and the desired subject variables 14, 24 and 34 generally are assumed to represent asset values. More specifically, the predictor variables 10 preferably are the 18 Eta factors identified in the '623 application (or another set of factors or measures) that have been chosen based on observational data indicating that they collectively account for (or reflect) most of the variation resulting from the larger macroeconomy (or otherwise attributable to causes that are systemic or non-specific to any particular subject variable). As a result, the predictor variables 10 are likely to be significantly statistically related to the values for a very large set of assets (e.g., accounting for variation other than that caused by very asset-specific factors) or other subject variables that are desired to be estimated.

In step 102, one or more individual sub-mappings 13, 23 and 33, as well as their more-specific input predictor variable instances 12, 22 and 32, respectively, are identified, using historical data values for the predictor variables 10 and for the subject variables 14, 24 and 34. Any of the techniques discussed above or in the related patent applications can be used in performing this step 102. In certain embodiments, a separate sub-mapping (e.g., 33) is identified for each subject variable (e.g., 34). In other embodiments, the various subject variables 14, 24 and 34 initially are aggregated together in an undifferentiated set, the specific instances of the predictor variables 10 (subject to any user-specified constraints, e.g., as noted above) that are most statistically related to each subject variable are identified, the subject variables sharing common predictor variable instances are grouped together, e.g., as sets 14, 24 and 34, and then the best sub-mappings 13, 23 and 33, respectively, are identified. Often, the sets 14, 24 and 34 are identified more or less simultaneously with the corresponding sub-mappings 13, 23 and 33, and any of the specific techniques discussed above may be used for this purpose, such as stepwise linear regression, neural network techniques, data-mining techniques, or any of the techniques discussed in the related patent applications.

In the preferred embodiments, each of the predictor variable instances (e.g., 12 for purposes of this paragraph) are specified both by reference to the nature of what it reflects (e.g., a specific definition of a macroeconomic variable 10, such as an inflation rate, as a function of time) and by reference to a relative time offset between a date (or time) for which such predictor variable instance 12 is valid and a date (or time) for which the subject variable(s) 14 are valid, with multiple time offsets (and, therefore, multiple predictor variable instances 12) potentially being specified for any given predictor variable 10 with respect to any given subject variable 14, with different weightings in the sub-mapping function 13 being applied to each. For example, the value of an individual predictor variable 10 might be a strong leading indicator of a particular subject variable 14 one week out, but only a moderate indicator of it one day out. This is because the strength of the statistical relationship between any given predictor variable 10 and a subject variable 14 usually will vary based on the specified relative time offset.

In addition to the predictor variable instances 12, 22 and 32, other information can be considered (i.e., input into the sub-mapping functions 13, 23 and 33) as well, such as anything that could be known and specified for the estimation of the relevant subject variable(s) 14, 24 and 34. For example, such additional information can include any other: observed information, survey data, forecasts, past estimation errors, calendrical data, seasonal effects, and/or even past values of the same or other subject variables 14, 24 and 34. When using past values of the same subject variables as are currently being estimated, the mapping function 7 (or sub-mapping function 13, 23 or 33) has aspects of a time-series prediction or estimation.

In step 103, data values for the subject variables 14, 24 and 34, with respect to the desired time(s), are estimated using available “current” data values for their corresponding predictor variable instances 12, 22 and 32 and using the one or more sub-mapping functions 13, 23 and 33 that were generated in step 102. As indicated above, these “current” data values are the values corresponding to the relevant mapping-specific time offsets (i.e., relative to the desired time(s) for the corresponding subject variables). It is noted that, for the purpose of this step 103, the predictor variable values may be actually measured or observed, and/or may be obtained as estimates from individuals and/or from other models (e.g., as discussed below in connection with step 107). If more than one estimate for the value of a given predictor variable 10 with respect to the same time has been obtained, then such values preferably are combined (e.g., using any of the techniques discussed here) to provide a single value for that predictor variable 10 with respect to that time. Also (or instead), if a predictor variable value is not available for the exact time specified by the relevant sub-mapping function, the available value nearest it in time may be used, or the value may be generated using interpolation or extrapolation. Otherwise, this step 103 typically is performed in a straightforward manner, e.g., by simply plugging the obtained values for the predictor variables 12, 22 and 32 into the sub-mapping functions 13, 23 and 33, respectively.

In step 105, a determination is made as to whether new estimates of the values for one or more of the subject variables (e.g., any or all of 14, 24 or 34) are to be generated. In this regard, the system 5 preferably can be configured to generate new estimates automatically on a periodic basis (e.g., daily, weekly or monthly) and/or to generate such estimates on demand (e.g., at the request of a user or another automated process). If one or more new estimates are in fact desired and values for the applicable predictor variable instances (e.g., 12, 22 with 32) to be input into the corresponding sub-mapping (e.g., 13, 23 or 33) are available, then processing returns to step 103 where such estimates are generated. Otherwise, processing proceeds to step 106.

In step 106, a determination is made as to whether an estimate of one or more of the predictor variables 10 is to be generated. As noted above, there are several circumstances in which estimates of values (e.g., values 41 and/or 42) for the predictor variables 10 would be useful. For example, one might wish to estimate the unemployment rate on a specified date or the average unemployment rate during a specified calendar month. That is, both the specific predictor variable(s) 10 (e.g., a particular macroeconomic measure) and a specific value for it (e.g., the desired point in time, such as a specific date, or the desired period of time, such as a specific calendar month, as the case may be) have been designated. A trigger for generating such estimates can occur automatically (e.g., on a periodic basis) when, for example, more frequent (or earlier) estimates of a particular predictor variable regularly are desired. In addition, or instead, such a trigger can occur on demand as a result of a request, e.g., made by a user or another automated process, such as in the event that an official announcement is unavailable or delayed. If such an estimate currently is desired and sufficient information is available for the other related variables, such as any or all statistically related subject variables (e.g., any or all of SVs 14, 24 or 34) and other predictor variables 10, then processing proceeds to step 107 to begin the subprocess of generating estimate(s) for the values 41 and 42 of identified predictor variable(s) 10 (referred to below as the target predictor variable(s)). If not, processing skips to step 110.

In step 107, estimates of any values of other variables (e.g., other predictor variables 10) that are intended to be used for estimating the target predictor variable(s) 41 and 42, and that are not otherwise available, are obtained. In this regard, it might be the case that, in addition to the target predictor variable(s) 41 and 42, the values for one or more other predictor variables 10 might not be available. In this case, although any or all of these missing values also (in this step 107) could be deemed to be additional target variables 41 and 42 that are to be estimated using the present technique, under certain circumstances it is more desirable to obtain separate estimates for such values and then use those estimated values in conjunction with the rest of the present technique.

One situation in which obtaining missing-value estimates in this step 107 would be desirable is when there are fairly reliable estimates for such values. Another is when designating such missing values as additional target variables 41 and 42 would result in a situation where there is a sufficiently large number of target variable values 41 and 42 that the ability to estimate all of them (or just the original desired ones) with the desired level of accuracy would be significantly impaired. Typically, a combination of these factors will be considered in determining whether to obtain an estimate for any particular missing value in this step 107 or to include the value as an additional target variable.

It is noted that missing values for any of the subject variables 14, 24 and 34 also can be evaluated in the same manner. However, in embodiments where many sub-mappings 13, 23 and 33 are used, the particular sub-mapping pertaining to the missing subject variable value usually can be just disregarded when estimating the values of the target variable values 41 and 42 in this process 100.

For those values that are in fact desired to be estimated in this step 107, any of a variety of different estimations may be used. For example, the desired estimates can be obtained from independent parties (e.g., a survey of expert or professional forecasters, or a combination forecast using clusteriztion as described in the related patent applications), or they can be calculated based on previously established statistical relationships with other variables whose relevant values are known with a desired level of accuracy.

In step 109, the target predictor variable values (along with any other target variables identified in step 107) are estimated. In the preferred embodiments, these estimates are generated using the same sub-mappings 13, 23 and 33 that previously were used to generate estimates for the subject variables 14, 24 and 34. As a result, the parameters for such sub-mappings 13, 23 and 33 already are known, at least implicitly, i.e., even if explicit values and/or even explicit relationships are not well-understood, as often would be the case with sub-mappings 13, 23 and/or 33 that have been generated, e.g., using neural networks or data-mining techniques. A variety of different approaches can be employed in this step 109. The main approaches involve essentially working backward from the sub-mappings 13, 23 and 33 in order to estimate the desired values of the target predictor variable(s). Where the individual sub-mappings are well-understood (e.g., as is often the case with linear mappings), it often will be possible to calculate one or more estimates for any given target predictor variable 41 or 42, e.g., using the inverse mapping function(s). On the other hand, where the sub-mappings are more complicated or not well-defined (e.g., where they have been generated using neural networks), a searching technique, such as subprocess 109B (with or without subprocess 109A), discussed below, often will be preferred.

In any event, in certain embodiments, particularly where values for the subject variables 14, 24 and 34 are not obtained on a fairly continual basis, the time(s) for which one or more of the estimated target predictor variables 12, 22 and/or 32 are valid might not correspond exactly to the desired time(s). In such cases, e.g., an estimated value close in time might be used, or the desired values may be interpolated or extrapolated.

Finally, in step 110 a determination is made as to whether the sub-mappings (e.g., any or all of sub-mappings 13, 23 and 33) should be updated, e.g., to reflect changed market conditions or other changed circumstances. Such updates can be performed on a regular, periodic basis (e.g., weekly, biweekly, monthly, quarterly, semi-annualy or annually), can be requested manually, and/or can be triggered (or at least recommended) automatically, e.g., based on observed increases in estimation errors (e.g., after verifying accuracy of the estimates generated in step 103 and/or in step 109) or based on observations of events that are likely to alter statistical relationships between the predictor variables and the subject variables. If a determination is made that any of the sub-mappings 13, 23 or 33 should be updated, then processing returns to step 102. Otherwise, processing returns to step 105.

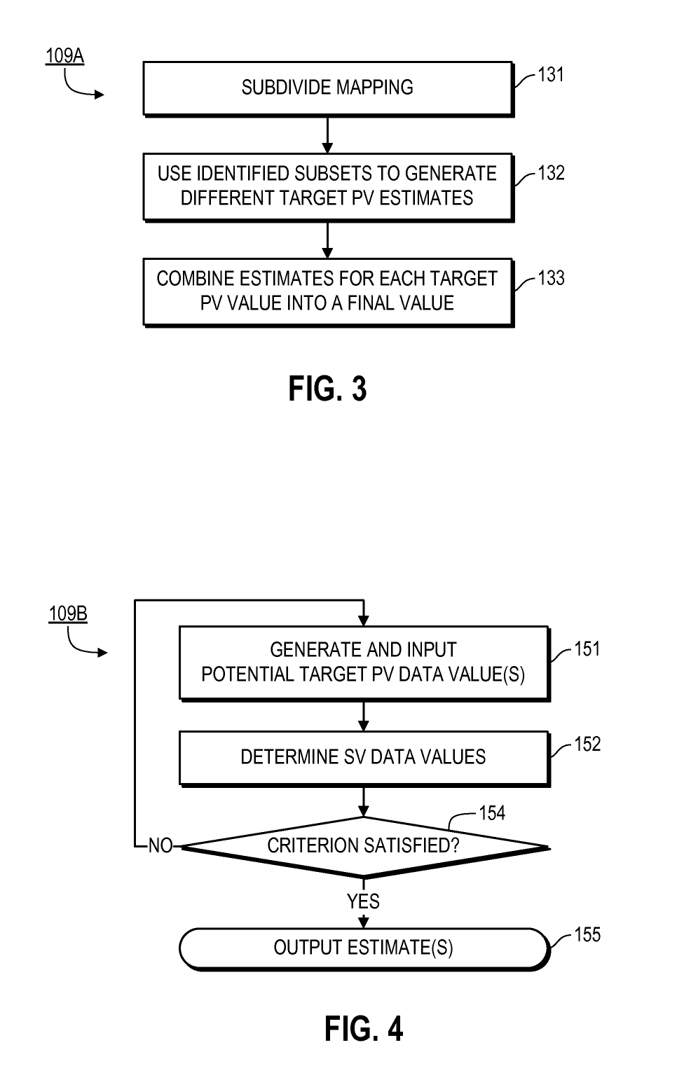

As noted above, the overall mapping function 7 can be divided into multiple different sub-mapping functions 13, 23 and 33 for the purpose of estimating values of the subject variables 14, 24 and 34, respectively. Similarly, the mapping function 7 can be divided into multiple different sub-mapping functions or subsets (e.g., 51 and 52, shown in FIG. 1) for the purpose of obtaining estimates of the target predictor variable values 41 and 42. One representative embodiment of an approach 109A that employs such subdivision is now discussed in reference to FIG. 3.

Initially, in step 131 any subdividing of mapping function 7 that might be beneficial to estimating the target predictor variable values 41 and 42 is performed. One advantage of such a subdivision is that it often makes it possible to restrict each subset (e.g., 51 or 52) to a smaller number of variables (e.g., at least a smaller set of the subject variables 14, 24 or 34), thereby simplifying the computations. Therefore, although described in connection with the particular sub-process 109A, such a subdivision often will be beneficial irrespective of the specific technique used to implement step 109. Any number of such smaller sub-mappings or subsets may be generated, and often there will be more than 10, 20, 50, 100, 200, 500 or 1,000 such sub-mappings or subsets.

In one particular embodiment, each subject variable (e.g., 34) has its own sub-mapping function (e.g., 33). If values for two target predictor variables 41 and 42 are to be estimated, then each subset defined in this step 131 typically will require a minimum of two such sub-mapping functions to be included in order to calculate unique estimates for both of such predictor variable values 41 and 42. However, more than two such sub-mapping functions can be included.

As discussed below, each such subset 51 or 52 will be used to generate an estimate of the data value(s) for some or all of the target predictor variables (e.g., using any of the optimization techniques noted above). Several different considerations can be taken into account in forming these smaller subsets 51 and 52. For example: (1) each original sub-mapping function (e.g., 13, 23 or 33) can be designated as a separate subset; (2) the subsets can be defined to minimize the number of target predictor variables within each; (3) the subsets can be defined such that each includes just enough information to uniquely determine the value(s) of the target predictor variable(s) that they are attempting to estimate; (4) each subset can include just a single subject variable or, possibly, multiple subject variables that are highly statistically related to each other; (5) the subsets can be defined such that the resulting estimates of the predictor variable value(s) are as close to independent of each other as reasonably practical; (6) each subset can include a set of subject variables whose values are as independent of each other as possible; and/or (7) any combination of the foregoing considerations can be used. More specifically, the subsets can be formed, e.g.: by solving for all possibilities, by applying a least squares methodology, by applying a computationally intensive sampling, resampling, Monte Carlo or other approach, or by using any other methodology resulting in sub-mapping functions that include at least the same number of subject variables as the number of target predictor variable values 41 and 42. In any event, any such subdivisions preferably are performed automatically, e.g., with the desired combination of the foregoing factors encoded into computer-executable process steps.

In addition to identifying individual subsets (e.g., 51 and 52), the present step 131 often will entirely exclude some of the sub-mappings 13, 23 and 33 (or, correspondingly, some of the subject variables 14, 24 or 34) from the portion of overall mapping 7 that is used to estimate the values of the target predictor variable values 41 and 42. In this regard, it typically will be desirable to use only the subject variables 14, 24 and 34 that have been empirically determined to be sufficiently statistically related to (or most statistically related to) the predictor variables 10, or at least to the target predictor variables for values 41 and 42. Thus, in certain embodiments a subset of the subject variables 14, 24 and 34 is selected so as to create a portfolio that replicates an Eta profile (as discussed in the '623 application) that is largely positive (or negative) with respect to the target predictor variables 41 and 42 and some other value, such as zero, with respect to the other Eta factors. For example, the subject variables 14, 24 and 34 having the greatest absolute value correlation with the target predictor variables 41 and 42 could be selected. Alternatively, the subject variables 14, 24 and 34 (and corresponding sub-mappings 13, 23 and 33) could be selected in any other way.

Next, in step 132 each of the different subsets (e.g., 51 and 52) is used to generate a different estimate for each target predictor variable 41 and 42 (and any other target variables) included within it. Additional detail regarding how these individual estimates can be generated is discussed below in connection with sub-process 109B, shown in FIG. 4. Typically, however, the approach is to work backward from the sub-mapping function(s) (e.g., 13 and 23) within the subsets (e.g., 51) to identify values for the target predictor variables 41 and 42 that when input, together with the other known predictor variable values (i.e., other than 41 and 42), result in the subject variable value(s) (e.g., 14 and 24) that are estimated by the subset. The collective result of this step 132 typically will be multiple estimates for at least some of the target predictor variable data values 41 and 42.

Therefore, in step 133 for each target predictor variable value 41 and 42 (together with any other target variable values) having multiple different estimates, such different estimates are combined to provide a single, composite estimate. Such different estimates can be combined, e.g., using a consensus, combination, optimal combination, and/or distribution of forecasts technique, and using any of a variety of summary statistics including statistics of central tendency (arithmetic mean, median, mode) or they can be summarized using “robust statistics” such as a “trimmed mean”, “trimmed median”, or “trimmed mode” (which would be obtained by excluding some portion of extreme values, say the top and bottom 1% of observations), or they can be optimally combined using regression or other weighting techniques. In embodiments where the target variables are assets, such as stocks, the assets can be placed into clusters (e.g., based on industry group, company size and/or any other statistic(s), such as directions and/or magnitudes of any common set of Eta Values for the various assets, as discussed in the '623 application), and then values or summary statistics from the clusters can be optimally combined. In certain embodiments, the estimates are combined using conventional techniques for generating consensus forecasts. In others, clustering and/or combination forecasting methods, e.g., as described in the related patent applications, and/or any such techniques discussed in the prior art are used. Still further, in others a composite estimate is generated using Kalman filtering or any other technique or combination of techniques (e.g., any of the techniques mentioned herein) for optimally combining different estimates.

In addition to combining the various estimates generated in step 132, any other estimates of the values of the predictor variable values also can be included to generate the desired composite estimates in this step 133. Such other estimates might, e.g., originate from individual experts, comprise summary statistics regarding relatively large-scale survey data, comprise combination forecasts using clusterization, and/or comprise estimates derived from one or more forecasting contests.

By omitting sub-process 109A, all of the predictor variable values 41 and 42 often can be identified simultaneously, using all available information and all known sub-mappings 13, 23 and 33. While such approaches can be useful, in certain circumstances they might require excessive computational resources, e.g., depending upon the numbers of sub-mappings and other variables involved.

Irrespective of whether or not the original mapping function 7 has been subdivided into multiple, smaller sub-mapping functions 51 and 52, the values of one or more target predictor variable values 41 and 42 (and any other target variable values) will be estimated based on a specified mapping or sub-mapping function (in the following discussion, simply referred to as the mapping). One sub-process 109B for doing so is now discussed in reference to FIG. 4. It is noted that sub-process 109B may be performed, e.g., to implement step 109 in its entirety (for embodiments in which no subdivision of the overall mapping function 7 is performed) or to implement step 132 (for embodiments in which step 109 includes sub-process 109A). In the latter case, sub-process 109B typically will be instantiated multiple times, once for each sub-mapping (e.g., 51 and 52).

Initially, in step 151 potential values for the target predictor variable values 41 and 42 (and any other target variables) are generated and input into the mapping. Preferably, a vector of the target predictor variable(s) 41 and 42 is defined. In the initial iteration of this step 151, an initial set of values is assigned to such variables. For example, the most recent values of the target predictor variables 41 and 42 may used as a starting point, or time-extrapolated values, based on the most recent values (e.g., using time-derivative estimates), may be used. In subsequent iterations of this step 151, modified values, based on one or more previously used values, preferably are used, as discussed in greater detail below.

In step 152, the mapping function is calculated (or otherwise performed) to generate output subject variable data value estimates. Preferably, this step 152 is simply a straightforward calculation using the values generated in step 151.

In step 154, a determination is made as to whether or not a specified criterion has been satisfied. In this regard, the sub-process 109B preferably executes a search across different potential values of the target predictor variables 41 and 42, along with the other known values of the predictor variables 40, to find the potential values that most closely result in the known values of the various subject variables 14, 24 and 34. For this purpose, any of a variety of different search methodologies may be employed, such as global searching, a genetic algorithm, simulated annealing, any other search optimization technique, or any combination of such techniques. Thus, the specific criterion used in this step 154 typically will be tied to the particular technique employed and the desired level of accuracy. Again, depending upon factors, it might be attempting to find the values that result in subject variable values that have the minimum variation (according to a specified cost function) from the actual known values, or it might be attempting to find values that result in a deviation metric (again, typically according to some specified cost function) that is below a pre-specified threshold. If the specified criterion has been satisfied, then processing proceeds to step 155, in which the estimated values for the target predictor variables 41 and 42 (and any other target variables, such as target subject variables produced in accordance with the mapping) are output.

Otherwise, processing returns to step 151 to generate the next set of target predictor variable values to be tried. These next values typically depend upon the particular search methodology being employed, but often will rely on a combination of the previous values used and how those values altered the output subject variable values. In addition, in order to avoid finding a local optimum that is not the true optimum, some amount of randomness and/or global searching preferably is incorporated.

According to one specific example, the predictor variables 40 are linearly related to the subject variables 14, 24 and 34 through the mapping 7. Initially, the process 100 obtains a dataset that includes the most recent value of each of the subject variables 14, 24 and 34, together with the most recently estimated coefficients for the mapping 7, e.g., with these estimated coefficients being different for each of the subject variables 14, 24 and 34. Such subject variables, in turn, typically would include monetary values for assets such as stocks, mutual funds, exchange traded funds (ETFs), other funds, commodities, and/or indexes, but also could include information regarding product demand, consumer preferences any other subject variables. Then, linear regression or any other estimation methodology (such as Least Absolute Deviations regression, neural networks, nonlinear regression and/or quadratic programming) is applied to find the common set of predictor variables 40 that when multiplied by the respective previously estimated coefficients would generate the overall “best fit” values for the subject variables 14, 24 and 34 such that the mapping 7, when evaluated using these estimated values, would be close (according to some optimization method, loss function, cost criterion, and/or decision rule, which preferably is minimum total squared error in the case of ordinary least squares regression). These estimated values for the predictor variables 40 preferably are then combined, e.g., using any of the techniques noted above in connection with step 133.

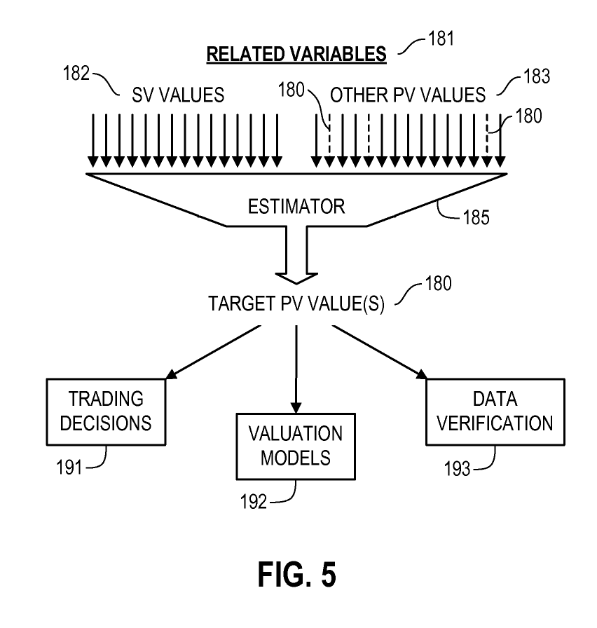

FIG. 5 is a block diagram showing interactions between exemplary components when estimating values of specified target predictor variable(s) 180 and then using such estimated values. As noted above, the estimates of values for the target predictor variable(s) 180 preferably are based on the data values of certain statistically related variables 181, which can include both subject variables 182 (i.e., the typical outputs of a mapping function 7) and the values of other predictor variables 183 (i.e., the typical inputs of the mapping function 7, but excluding the values of the target predictor variable(s) 180).

Estimator 185 typically is implemented on one or more computer servers or other processor-based devices and can employ any of a variety of different techniques. In one embodiment discussed above, an optimization search is performed across different values of the target predictor variable(s) 180. However, the technique employed also (or instead), e.g., can construct a forecasting model using econometric and/or time series methods and thereby obtain a series of forecasts for the target predictor variable(s) 180. Then, using historical data for the subject variables 14, 24 and 34 (which, e.g., can include securities, indexes and/or other assets), a combination forecasting equation can be estimated using a conventional econometric model, integrated with the values of the subject variables 14, 24 and 34.

In any event, the resulting estimates of the predictor variable values 180 can be used for a variety of different purposes. For instance, they can be used to influence or automatically effect asset trading decisions 191 (e.g., purchasing and/or selling assets). Trading techniques, such as some options strategies, often will be more or less profitable depending on what the announcement value is for various economic variables. Therefore, for example, the target variable value estimates 180 (which often can be provided earlier than the official announcement and/or can be available even if the official announcement has been suspended) can be directly input (instead of or in addition to the announced values) into existing systems for making automated trading decisions and/or for making automated trading recommendations (e.g., when the current market value of an asset differs by at least a specified amount from the estimated monetary value). The latter types of systems are similar to the former, but rather than making a binary decision to purchase or not purchase, sell or not so, recommendation systems typically provide alerts with varying levels of recommendations (e.g., old, moderate sell recommendation, strong sell recommendation, moderate by recommendation, strong buy recommendation). Both types of systems typically base their actions and recommendations on the difference between the actual market value of an asset and its value estimated using the input macroeconomic variable and other values and, sometimes, the calculated amount of uncertainty in the estimate(s).

In addition, such estimates 180 can be input into a variety of different valuation models 192 that use macroeconomic data values as inputs. Such valuation models can be used, e.g., for valuing entire companies, divisions of companies, publicly traded assets or more unique assets, such as real estate or intellectual property. Those valuations, in turn, can be used, e.g., to automatically effect and/or automatically recommend a variety of different business decisions.

Still further, the estimates 180 can be used for data verification 193, e.g., to verify the accuracy of information that is being released by the responsible data agencies. In such a case, a sufficiently large discrepancy between the estimates 180 and the announcement data might provide a basis for investigating the discrepancy.

The end result of each of the foregoing uses typically will be a more efficient allocation of resources, either for a particular company or entity, or for a larger society as a whole.

In the foregoing techniques, individual target predictor variable values 41 and 42, taken from a set of predictor variables 10, are estimated. In many embodiments, the set of predictor variables 10 will be fairly limited (e.g., to 18 different macroeconomic measures). In cases where the values other of other macroeconomic measures or, more generally, variables other than a small set of predictor variables 10 are desired to be estimated, the present techniques can be used in conjunction with a two-stage estimation approach, such as is described in the '062 application.

Also, although the foregoing discussion mainly focuses on financial and economic variable estimation, any of a variety of other types of data values may be estimated using the present techniques, such as social and/or behavioral measures (e.g., preferences or traffic patterns), or even physics or engineering quantities (e.g., ballistic or missile targeting/aiming quantities). More generally, the present techniques, particularly to the extent employing a combination of both “forward” and “backward” estimations, can be applied anywhere that predictions or other types of estimates are desired and where there is in place (or where it is possible to generate) an empirical structure relating a set of one or more predictor variables to another set of one or more subject variables.

It is noted that, typically, the asset monetary values mentioned above can be directly obtained from the relevant markets (such as the New York Stock Exchange) and/or from other publicly available information and, except in extreme circumstances, will always be available. On the other hand, the macroeconomic data values might not be provided, might be delayed or might be subject to varying degrees of accuracy.

### System Environment.

Generally speaking, except where clearly indicated otherwise, all of the systems, methods, functionality and techniques described herein can be practiced with the use of one or more programmable general-purpose computing devices. Such devices (e.g., including any of the electronic devices mentioned herein) typically will include, for example, at least some of the following components coupled to each other, e.g., via a common bus: (1) one or more central processing units (CPUs); (2) read-only memory (ROM); (3) random access memory (RAM); (4) input/output software and circuitry for interfacing with other devices (e.g., using a hardwired connection, such as a serial port, a parallel port, a USB connection or a FireWire connection, or using a wireless protocol, such as radio-frequency identification (RFID), any other near-field communication (NFC) protocol, Bluetooth or a 802.11 protocol); (5) software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system, which networks, in turn, in many embodiments of the invention, connect to the Internet or to any other networks; (6) a display (such as a cathode ray tube display, a liquid crystal display, an organic light-emitting display, a polymeric light-emitting display or any other thin-film display); (7) other output devices (such as one or more speakers, a headphone set and/or a printer); (8) one or more input devices (such as a mouse, touchpad, tablet, touch-sensitive display or other pointing device, a keyboard, a keypad, a microphone and/or a scanner); (9) a mass storage unit (such as a hard disk drive or a solid-state drive); (10) a real-time clock; (11) a removable storage read/write device (such as a flash drive, any other portable drive that utilizes semiconductor memory, a magnetic disk, a magnetic tape, an opto-magnetic disk, an optical disk, or the like); and/or (12) a modem (e.g., for sending faxes or for connecting to the Internet or to any other computer network). In operation, the process steps to implement the above methods and functionality, to the extent performed by such a general-purpose computer, typically initially are stored in mass storage (e.g., a hard disk or solid-state drive), are downloaded into RAM, and then are executed by the CPU out of RAM. However, in some cases the process steps initially are stored in RAM or ROM and/or are directly executed out of mass storage.

Suitable general-purpose programmable devices for use in implementing the present invention may be obtained from various vendors. In the various embodiments, different types of devices are used depending upon the size and complexity of the tasks. Such devices can include, e.g., mainframe computers, multiprocessor computers, one or more server boxes, workstations, personal (e.g., desktop, laptop, tablet or slate) computers and/or even smaller computers, such as personal digital assistants (PDAs), wireless telephones (e.g., smartphones) or any other programmable appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented by a general-purpose processor executing software and/or firmware, by dedicated (e.g., logic-based) hardware, or any combination of these approaches, with the particular implementation being selected based on known engineering tradeoffs. More specifically, where any process and/or functionality described above is implemented in a fixed, predetermined and/or logical manner, it can be accomplished by a processor executing programming (e.g., software or firmware), an appropriate arrangement of logic components (hardware), or any combination of the two, as will be readily appreciated by those skilled in the art. In other words, it is well-understood how to convert logical and/or arithmetic operations into instructions for performing such operations within a processor and/or into logic gate configurations for performing such operations; in fact, compilers typically are available for both kinds of conversions.

It should be understood that the present invention also relates to machine-readable tangible (or non-transitory) media on which are stored software or firmware program instructions (i.e., computer-executable process instructions) for performing the methods and functionality of this invention. Such media include, by way of example, magnetic disks, magnetic tape, optically readable media such as CDs and DVDs, or semiconductor memory such as various types of memory cards, USB flash memory devices, solid-state drives, etc. In each case, the medium may take the form of a portable item such as a miniature disk drive or a small disk, diskette, cassette, cartridge, card, stick etc., or it may take the form of a relatively larger or less-mobile item such as a hard disk drive, ROM or RAM provided in a computer or other device. As used herein, unless clearly noted otherwise, references to computer-executable process steps stored on a computer-readable or machine-readable medium are intended to encompass situations in which such process steps are stored on a single medium, as well as situations in which such process steps are stored across multiple media.

The foregoing description primarily emphasizes electronic computers and devices. However, it should be understood that any other computing or other type of device instead may be used, such as a device utilizing any combination of electronic, optical, biological and chemical processing that is capable of performing basic logical and/or arithmetic operations.

In addition, where the present disclosure refers to a processor, computer, server, server device, computer-readable medium or other storage device, client device, or any other kind of apparatus or device, such references should be understood as encompassing the use of plural such processors, computers, servers, server devices, computer-readable media or other storage devices, client devices, or any other such apparatuses or devices, except to the extent clearly indicated otherwise. For instance, a server generally can (and often will) be implemented using a single device or a cluster of server devices (either local or geographically dispersed), e.g., with appropriate load balancing. Similarly, a server device and a client device often will cooperate in executing the process steps of a complete method, e.g., with each such device having its own storage device(s) storing a portion of such process steps and its own processor(s) executing those process steps.

As used herein, the term “coupled”, or any other form of the word, is intended to mean either directly connected or connected through one or more other elements or processing blocks.

### Additional Considerations.

In the event of any conflict or inconsistency between the disclosure explicitly set forth herein or in the attached drawings, on the one hand, and any materials incorporated by reference herein, on the other, the present disclosure shall take precedence.

In the foregoing discussion, the term “value” when used in reference to a variable refers to the data value of the variable (e.g., in reference to a particular point in time), unless otherwise stated. When used in reference to an asset variable, this data value also refers to a monetary (or intrinsic) value of the asset, unless otherwise stated. Exemplary monetary values that can be used for asset variables include market prices, market prices adjusted for events such as stock splits and/or dividend payments, or any other indication of intrinsic or monetary value.

An “asset”, as used herein, potentially could be a single item (such as a single share of a particular stock or fund, a particular bond or a specific quantity of a particular commodity) or a collection of items (such as the S&P 500, any another index, the Dow Jones Industrial Average, any other average, or an investment fund).

Words such as “optimal”, “optimize”, “minimize”, “best” and similar words are used throughout the above discussion. However, it should be understood that such words are not used in their absolute sense, but rather are intended to be viewed in light of other constraints, such as user-specified constraints and objectives, as well as cost and processing constraints.

In certain instances, the foregoing description refers to clicking or double-clicking on user-interface buttons (typically in reference to desktop computers or laptops), touching icons (typically in reference to devices with touchscreens), dragging user-interface items, or otherwise entering commands or information via a particular user-interface element or mechanism and/or in a particular manner. All of such references are intended to be exemplary only, it being understood that each such reference, as well as each other aspect of the present invention as a whole, encompasses entry of commands or information by a user in any of the ways mentioned herein or in any other known manner, using the same or any other user-interface mechanism, with different entry methods and different user-interface elements being most appropriate for different types of devices and/or in different situations. In addition, or instead, any and all references to inputting commands or information should be understood to encompass input by an automated (e.g., computer-executed) process.

In the above discussion, certain methods are explained by breaking them down into steps listed in a particular order. However, it should be noted that in each such case, except to the extent clearly indicated to the contrary or mandated by practical considerations (such as where the results from one step are necessary to perform another), the indicated order is not critical but, instead, that the described steps can be reordered and/or two or more of such steps can be performed concurrently.

References herein to a “criterion”, “multiple criteria”, “condition”, “conditions” or similar words which are intended to trigger, limit, filter or otherwise affect processing steps, other actions, the subjects of processing steps or actions, or any other activity or data, are intended to mean “one or more”, irrespective of whether the singular or the plural form has been used. For instance, any criterion or condition can include any combination (e.g., Boolean combination) of actions, events and/or occurrences (i.e., a multi-part criterion or condition).

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

In the discussions above, the words “include”, “includes”, “including”, and all other forms of the word should not be understood as limiting, but rather any specific items following such words should be understood as being merely exemplary.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention are to be considered as within the scope thereof as limited solely by the claims appended hereto.

What is claimed is:

1. A non-transitory computer-readable medium storing computer-executable process steps for estimating the value of a macroeconomic measure, said process steps comprising steps to:
(a) generate a mapping from a first set of data values for macroeconomic variables to monetary values for a second set of assets based on historical data values for the macroeconomic variables and historical monetary values of the assets;
(b) generate estimates of the monetary values of the assets by inputting data values for macroeconomic variables into the mapping; and
(c) generate an estimate of a data value for at least one of the macroeconomic variables using the mapping and known monetary values for the assets.

2. A non-transitory computer-readable medium according to claim 1, wherein step (c) comprises substeps to: (i) input different potential data values for said at least one of the macroeconomic variables into the mapping to generate a plurality of additional sets of estimates for the monetary values of the individual assets; and (ii) identify the estimated data value for said at least one of the macroeconomic variables by comparing results of substep (i) to the known monetary values for the individual assets.

3. A non-transitory computer-readable medium according to claim 2, wherein said step (c) uses at least one of global searching, a genetic algorithm or simulated annealing.

4. A non-transitory computer-readable medium according to claim 2, wherein said substep (i) generates the different potential data values using at least one of global search or added randomness.

5. A non-transitory computer-readable medium according to claim 1, wherein the mapping includes a plurality of sub-mappings, and wherein step (c) comprises substeps to: (i) use a set of the sub-mappings to generate a plurality of different estimated data values for said at least one of the macroeconomic variables; and then (ii) combine said different estimated data values to provide a composite estimated data value for each of said at least one of the macroeconomic variables.

6. A non-transitory computer-readable medium according to claim 5, wherein different ones of the sub-mappings in the set are for estimating monetary values of different ones of the individual assets.

7. A non-transitory computer-readable medium according to claim 5, wherein each of at least a majority of the sub-mappings in the set are for estimating a monetary value of exactly one of the individual assets.

8. A non-transitory computer-readable medium according to claim 5, further comprising a substep of generating the sub-mappings by using at least one of: a least squares, sampling, resampling or Monte Carlo approach.

9. A non-transitory computer-readable medium according to claim 1, wherein the first set includes at least 12 macroeconomic variables and the second set includes at least 100 assets.

10. A non-transitory computer-readable medium according to claim 1, wherein said step (c) comprises a substep to identify a subset of the assets that satisfy a criterion pertaining to statistical relatedness to data values for the macroeconomic variables, and wherein the estimate of the data value for said at least one of the macroeconomic variables uses the known monetary values only for said subset of the assets.

11. A non-transitory computer-readable medium according to claim 1, wherein said process steps further comprise a step to:
(d) at least one of purchase an asset, sell an asset, recommend the purchase of an asset or recommend the sale of an asset, based on the estimate of the data value for said at least one of the macroeconomic variables.

12. A non-transitory computer-readable medium according to claim 1, wherein said step (d) employs an asset valuation model using said at least one of the macroeconomic variables as an input.

13. A non-transitory computer-readable medium according to claim 12, wherein said step (d) compares a valuation estimate for a target asset output by said asset valuation model to a corresponding market value of said target asset.

14. A method of estimating the value of a macroeconomic measure, by using a processor-based device to:
(a) generate a mapping from a first set of data values for macroeconomic variables to monetary values for a second set of assets based on historical data values for the macroeconomic variables and historical monetary values of the assets;
(b) generate estimates of the monetary values of the assets by inputting data values for macroeconomic variables into the mapping; and
(c) generate an estimate of a data value for at least one of the macroeconomic variables using the mapping and known monetary values for the assets.

15. A system for estimating the value of a macroeconomic measure, comprising:
(a) means for generating a mapping from a first set of data values for macroeconomic variables to monetary values for a second set of assets based on historical data values for the macroeconomic variables and historical monetary values of the assets;
(b) means for generating estimates of the monetary values of the assets by inputting data values for macroeconomic variables into the mapping; and
(c) means for generating an estimate of a data value for at least one of the macroeconomic variables using the mapping and known monetary values for the assets.
